(19) United States
(12) Patent Application Publication
(10) Pub. No.: US 2007/0288919 A1
(43) Pub. Date: Dec. 13, 2007

(54) System for Supporting Preparation of Schedule for Development Project and the Method Thereof

(76) Inventors: Hisatoshi Adachi, Tokyo (JP); Makoto Kano, Yokohama-shi (JP); Akio Koide, Yokohama-shi (JP); Toshihiko Nakazawa, Tokyo (JP)

Correspondence Address: W. Riyon Harding;International Business Machines Corporation, 972 E, 1000 River Street, Essex Junction, VT, 05452, US

(21) Appl. No.: 11/751,797

(22) Filed: May 22, 2007

(30) Foreign Application Priority Data
Jun. 8, 2006 (JP) 2006-159751

(51) Int. Cl. G06F 9/445

(52) U.S. Cl. 717/174

(57) ABSTRACT

A system for and method of supporting preparation of an operation schedule table for a development project, including an input accepting section for accepting, for each of a plurality of components to be developed, an input of a utilization method by which a first development project having a timetable already prepared is used in a second development project for which a new timetable is generated; a plan conversion section for converting, for each of the components, a plurality of operation processes planned in the first development project based on the utilization method for each of the components, to generate a plurality of operation processes for developing the components in the second development project; and a schedule section for scheduling the respective operation processes to generate a timetable for the second development project.

### CROSS REFERENCES TO RELATED APPLICATIONS

This application is related to Japan Patent Application No. 2006-159751, filed Jun. 8, 2006.

### FIELD OF THE INVENTION

The present invention relates to a system for supporting preparation of a timetable for a development project and a method thereof. In particular, the present invention relates to a system and a method thereof for generating a timetable for a new development project, based on an input from a user, and using a already generated timetable for a development project.

### BACKGROUND OF THE INVENTION

In recent years, the automotive industry has used a strategy to promote the sales by selling new products one after another by reducing the time required for the products to be marketable. By this strategy, the respective automotive companies bring many new cars to the market. Under the market environment as described above, a need has been caused to reduce the time required for products to be marketable and to reduce the cost required for the development. In order to satisfy the need as described above, more components (that are a part occupying a part of a finished product) have been increasingly shared among different vehicle types.

Component sharing is classified into the following two types.

(1) Sharing components with a development project of “parent vehicle type”

Components for a vehicle type already developed are directly used for a newly-planned vehicle type. Or, component are partially modified and used for a newly-planned vehicle type. The sharing of components with a development project of “parent vehicle type” may be used not only for a model change of the single vehicle type but also for the development of a totally different vehicle.

(2) Sharing of components with a development project of “elder brother vehicle type”

In the case of a plurality of vehicle types for which development periods are overlapping, designs of some components may be shared. For example, the sharing of components with a development project of “elder brother vehicle type” applies to a plurality of vehicle types for which the brand is identical but grades and options are different.

Hereinafter, reference publications are introduced.

[Patent Publication 1] Japanese Unexamined Patent Publication No. 2004-110102

[Non-patent Publication 1] MS Project (http://www.microsoft.com/japan/office/project/prodinfo/default.mspx)

[Non-patent Publication 2] “Kakushinteki Seisan Scheduling Nyumon—Zikan no Nayami wo Toku Syuhou” (Sato Tomoichi, JMA Management Center Publishing, 2000/04)

### SUMMARY OF THE INVENTION

A timetable for a new development project may be generated based on an operation schedule generated for a development project for the above-described parent vehicle type or elder brother vehicle type. The operation schedule specifies, for every operation process, a time at which the operation process is started and completed and the man-hour required to execute the operation process for example. Development of one component frequently requires a great number of operation processes. For example, in order to develop a certain auto part, requirements for the design of the part, design definitions for the shape and cross section for example, and verification of whether various constraints are satisfied are required. Therefore, even when a development plan for a certain component is made, it is sometimes very difficult to closely investigate an existing operation schedule and to extract useful information from the schedule. Furthermore, the use of information from the existing operation schedule is more difficult when development projects for a certain vehicle type and an elder brother vehicle type are shared because the consistency with the operation period based on the development project of the elder brother vehicle type must be maintained. A manager of a development project may need to refer to existing development projects to estimate the outline of the operation plan and required man-hours, in order to prepare a complete operation schedule in detail. Close examination of the existing operation schedules requires an excessively-long time for the estimation.

Related techniques for the invention include Patent Publication 1 and Non-patent Publication 1 (Non-patent Publication 2 will be described in an embodiment). Patent Publication 1 and Non-patent Publication 1 are common to the invention of the present application in that the preparation of a timetable for a development project is supported or automated. However, Patent Publication 1 does not describe how to efficiently prepare a timetable for a development project in order to realize common components and a co-development. The technique according to Non-patent Publication 1 also cannot efficiently prepare a timetable for a development project in order to realize common components and a co-development.

In view of the above, it is an object of the present invention to provide a system, a method, and a program product that can solve the above problems. This object is achieved by the combination of features described in independent claims. Dependent claims specify further advantageous examples of the present invention.

In order to solve the above problem, the present invention provides a system for supporting preparation of a timetable for a development project, including an input accepting section for accepting, for each of a plurality of components to be developed, an input of a utilization method by which a first development project having a timetable already prepared is used in a second development project for which a new timetable is prepared; a plan conversion section for converting, for each of the components, a plurality of operation processes planned in the first development project based on the inputted utilization method for each of the components, to generate a plurality of operation processes for developing the components in the second development project; and a schedule section for scheduling, based on the respective generated operation processes, the respective operation processes to output a timetable for the second development project. It is noted that the outline of the above invention does not recite all equivalent features of the present invention and subcombinations of these groups of the features are included within the scope and spirit of this invention.

According to the present invention, an operation for preparing a timetable for a development project is efficiently performed.

### BRIEF DESCRIPTION OF THE DRAWINGS

FIG. 1 illustrates the outline of a development project DB apparatus 20, and a preparation support system 30.

FIG. 2A illustrates an example of the structure of the data stored in the development project DB apparatus 20.

FIG. 2B is a conceptual diagram illustrating the dependence relationship shown in FIG. 2A.

FIG. 3 illustrates a functional structure of the preparation support system 30.

FIG. 4 illustrates an example of the data structure of corresponding data 40.

FIG. 5 shows an example of a display by the display section 300.

FIG. 6 illustrates the flow of the processing in which the preparation support system 30 converts an operation process based on an accepted input.

FIG. 7 shows the details of the processing in S610.

FIG. 8 shows the details of the processing in S620.

FIG. 9A illustrates a processing for incorporating operation processes of a component when the component is subjected to a co-development.

FIG. 9B illustrates a processing for incorporating operation processes of a component when the component is subjected to a co-development.

FIG. 9C illustrates a processing for incorporating operation processes of a component when the component is subjected to a co-development.

FIG. 10A illustrates a processing for converting operation processes of a component when the component is reused or deleted.

FIG. 10B illustrates a processing for converting operation processes of a component when the component is reused or deleted.

FIG. 10C illustrates a processing for converting operation processes of a component when the component is reused or deleted.

FIG. 11 shows an example of a hardware configuration of an information processing apparatus 100 functioning as the preparation support system 30.

### DETAILED DESCRIPTION

Hereinafter, the present invention will be described through the best mode for carrying out the invention (referred to as embodiment). However, the following embodiments do not limit the invention according to the claims and all combinations of features described in the embodiments are not always required for means for solving the problem of the invention.

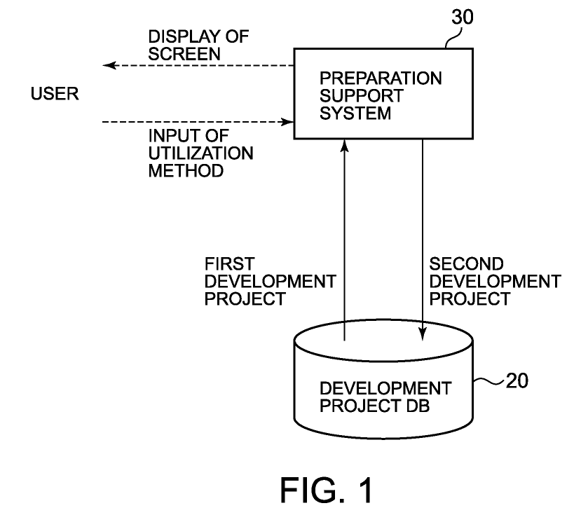

FIG. 1 illustrates the outline of a development project DB apparatus 20 and a preparation support system 30. The development project DB apparatus 20 stores therein a plurality of already-prepared schedules for development projects. A timetable for a development project includes, for each of a plurality of components to be developed, an operation time schedule for a plurality of operation processes for developing the component. The development project may be the one for which the development is already completed, the one for which the development is to be started, or the one for which the development is now in progress, as far as the timetable has been generated.

The preparation support system 30 reads a previously prepared timetable from the development project DB apparatus 20 for a first development project. Then, the preparation support system 30 displays an input screen to a user, and asks the user to provide a utilization method. System 30 prepares a new timetable in which the first development project is used in a second development project. Based on the utilization method, the preparation support system 30 converts the timetable for the first development project and generates the timetable for the second development project. The timetable for the second development project is stored in development project DB apparatus 20.

According to this embodiment, preparation support system 30 creates a timetable for the second development project for each of a plurality of components to be developed from the utilization method used by the first development project. This eliminates the need for closely investigating an existing operation plan to find a part that can be used, thus reducing the burden on a user or a manager. Therefore, a project is efficiently executed when there is co-development of a part between two or more development projects.

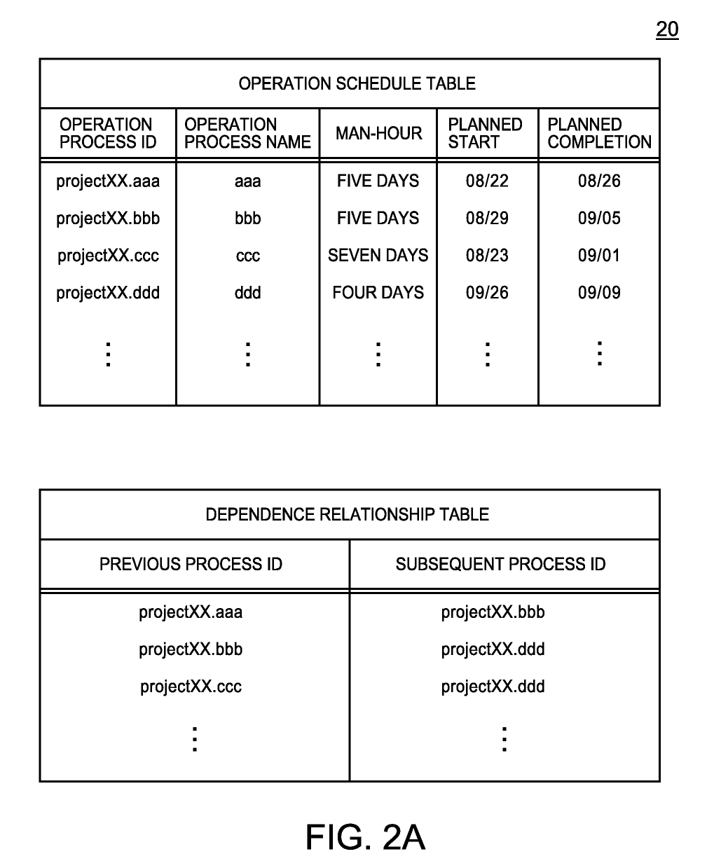

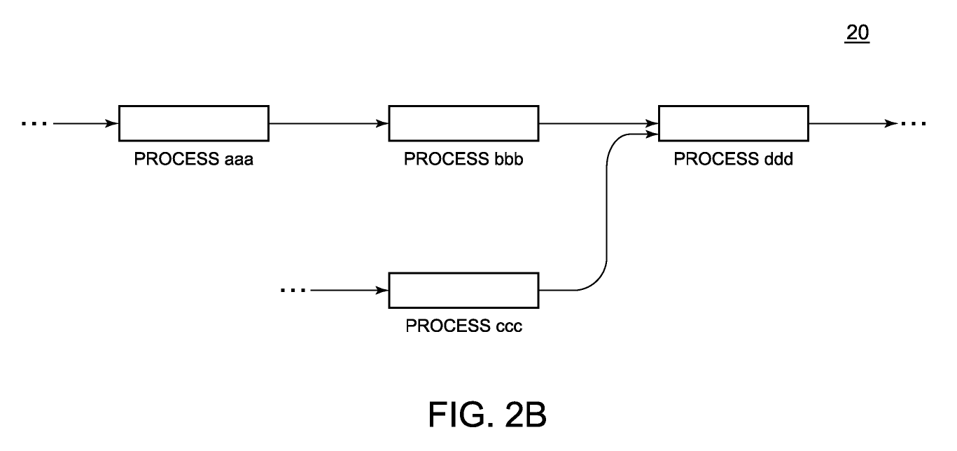

FIG. 2A illustrates an example of the structure of the data stored in the development project DB apparatus 20. FIG. 2A illustrates one of a plurality of development projects stored in the development project DB apparatus 20. This project is an example of the first development project according to the present invention and is referred to herein as project XX. The development project DB apparatus 20 has an operation schedule table for storing an operation plan for the project XX. In the operation schedule table, the development project DB apparatus 20 stores therein an ID of an operation process for developing a component; the name of the operation process; a man-hour required for the operation process; a date at which the operation process is to be started; and a date at which the operation process is to be completed. Each entry related to the project is associated with each of the other entries. For example, the name of one of the operation processes in project XX is “aaa”, the ID is “project XX .aaa”, the required man-hour is five days, the date at which the operation process is to be started is August 22, and a date at which the operation process is planned to be completed is August 26. In addition, the operation schedule table may include, for every operation process, information for specific contents of the operation and a responsible person.

The development project DB apparatus 20 also stores therein a dependence relationship table for project XX. The dependence relationship table includes a dependence relationship based on which a plurality of operation processes depend on other operation processes. Specifically, the development project DB apparatus 20 stores therein an ID of an operation process as a previous process and an ID of a subsequent operation process and associates the two. For example, the development project DB apparatus 20 stores the project XX .aaa as a previous process and stores the project XX .bbb as a corresponding subsequent process. Specifically, the project XX .aaa is a previous process of project XX .bbb.

FIG. 2B is a conceptual diagram illustrating the dependence relationship example shown in FIG. 2A. According to the dependence relationship table of FIG. 2A, the operation process bbb is a subsequent process of the operation process aaa and depends on the result of the operation process aaa. Thus, a link is provided from a node representing the operation process aaa to a node representing an operation process bbb. An operation process ddd is a subsequent process of the operation process bbb and depends on the result of the operation process bbb. Thus, a link is provided from a node representing the operation process bbb to a node representing the operation process ddd. The operation process ddd is a subsequent process of an operation process ccc and depends on the result of the operation process ccc. Thus, a link is provided from a node representing the operation process ccc to a node representing the operation process ddd. A development project is represented by data having a structure in which nodes representing the respective operation processes are connected via links based on the dependence relationship.

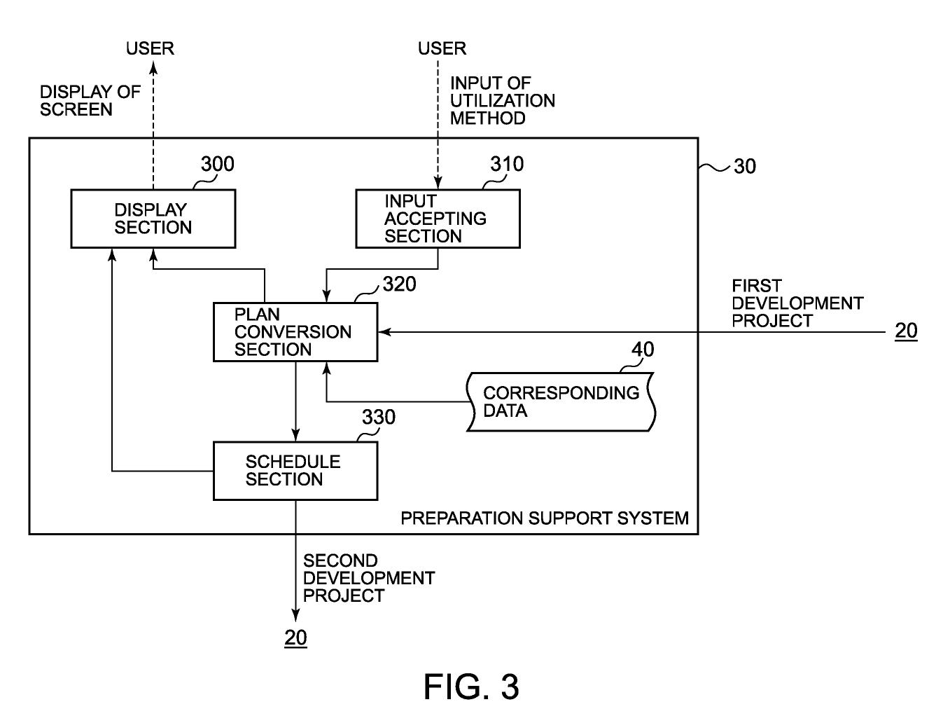

FIG. 3 illustrates a functional structure of the preparation support system 30. The preparation support system 30 has a display section 300, an input accepting section 310, a plan conversion section 320, and a schedule section 330. The display section 300 displays an input screen to a user in order to accept an input from the user for a utilization method by which the first development project (e.g., project XX) having a timetable already prepared is used for the second development project for which a new timetable is prepared. The input accepting section 310 accepts, for each of a plurality of components to be developed, an input of the utilization method by which the first development project is used for the second development project. The plan conversion section 320 reads the first development project from the development project DB apparatus 20 in order to convert the timetable of the first development project into a timetable for the second development project. The first development project to be converted is selected from among a plurality of developments stored in the development project DB apparatus 20 based on an input from the user.

Based on the timetable of the first development project, the plan conversion section 320 refers to the corresponding data 40 to prepare a timetable for the second development project. Specifically, for each of the components, the plan conversion section 320 converts a plurality of operation processes planned by the first development project based on the utilization method for the component, thereby generating a plurality of operation processes for developing the component in the second development project. For example, when plan conversion section 320 receives an input specifying that a component for which the development is already planned by the first development project is subject to a co-development with the second development project, plan conversion section 320 incorporates the operation process for the component in the first development project into the second development project. Based on the respective operation processes, schedule section 330 schedules the respective operation processes and stores the result as a timetable for the second development project in the development project DB apparatus 20. For example, if schedule section 330 recognizes that the time schedule for a component is already determined and cannot be changed, schedule section 330 prepares an operation time schedule of other operation processes that depend on the fixed operation processes or on which the fixed operation processes depends. Operation processes may also be scheduled using an existing technique such as forward scheduling, which is illustrated in Non-patent Publication 2. The results may be displayed by the display section 300.

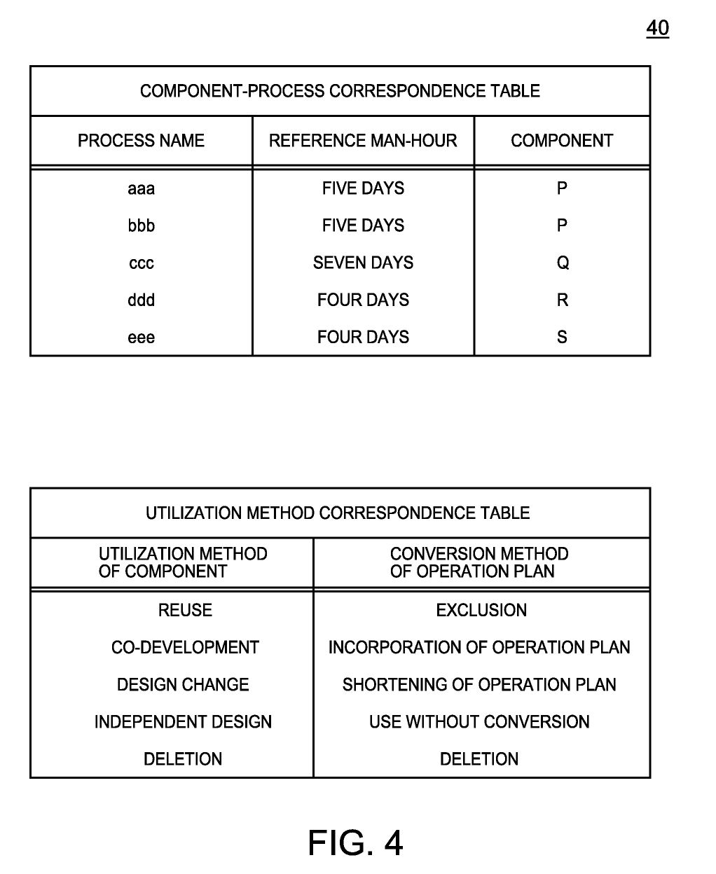

FIG. 4 illustrates an example of the data structure of the corresponding data 40. The corresponding data 40 includes a component-process correspondence table. The component-process correspondence table stores the process names of a plurality of operation processes for developing components and reference values of man-hours required for the respective operation processes. For example, development of a component P requires the operation process aaa and the operation process bbb. Each operation process has a reference man-hour of five days.

The development of a certain component frequently requires a plurality of operation processes. For example, when the component P is an auto part, the size of the auto part may be limited by the position of another part adjacent to the auto part. Thus, a process is required to determine a constraint such as the size or attachment angle of the component P. This process should be processed sooner than other processes. Furthermore, the determination of the size or attachment angle must be followed by operation processes to design the component P based on the determined size or attachment angle. Designing component P requires, in addition to an appearance diagram for determining an outer dimension of the component P, preparation of a predetermined cross sectional view for example. Preparation of such a drawing constitutes an independent operation process. Preparation of such a drawing also requires operation processes to verify that the completed design satisfies the original constraint. Corresponding data 40 includes process names of all such operation processes which correspond to component P.

It is noted that FIG. 4 is an example of the development of an automobile. Required components and types of operation processes therefore, are substantially the same even for a different vehicle type. For example, any vehicle type of an automobile requires components such as an engine and a transmission. An operation plan for an unnecessary component can be deleted when a user specifies.

The corresponding data 40 also includes a utilization method correspondence table. The utilization method correspondence table includes a utilization method for the first project for which a timetable is already prepared, and a conversion method of operation processes performed by the plan conversion section 320 in accordance with the utilization method. When the plan conversion section 320 receives an input specifying that a component having substantially the same design as that of a component developed in an already-completed project is to be developed, the plan conversion section 320 searches for a utilization method for the component by searching from the utilization method correspondence table and uses a conversion method corresponding to a utilization method of reuse. Based on “exclusion” founded by the search, the plan conversion section 320 excludes from the second development project operation processes corresponding to the component for the first development project. The reason why the operation processes are excluded is that the design obtained by the first development project may be directly used and the operation process is unnecessary in the second development project.

As described above, the utilization method correspondence table is referred to by plan conversion section 320 and has a function to show a correspondence between a utilization method and a conversion process.

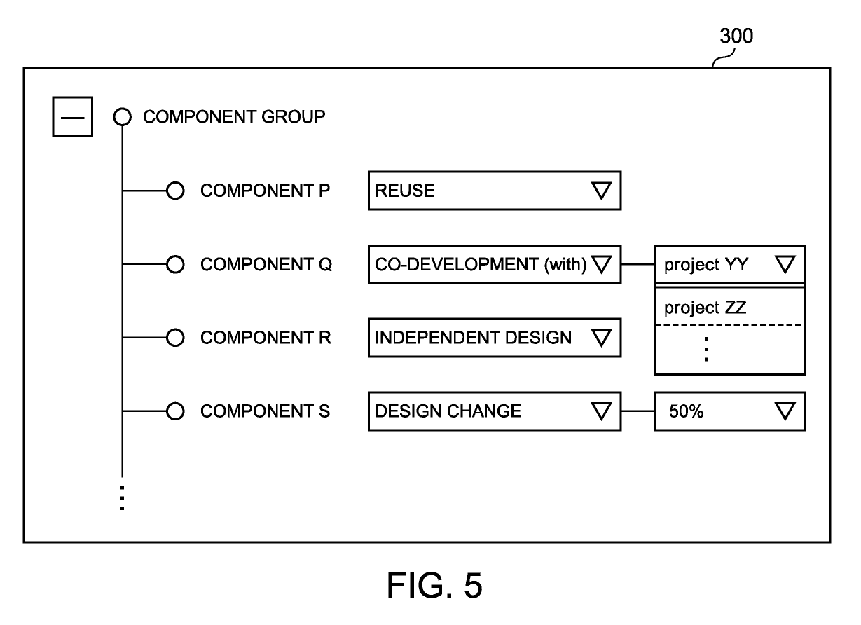

FIG. 5 shows an example of a display by the display section 300. As shown in FIG. 5, the display section 300 displays an input screen for accepting input information for every component. The information includes a utilization method for the first development project corresponding to a selected component. For example, display section 300 displays names of a plurality of components that may be covered by the second development project. The names are displayed in such a manner that the components are classified into component groups depending on their characteristics. FIG. 5 shows a certain component group in which a component P, a component Q, a component R, and a component S are displayed.

The term “component group” means, for example, a collection of subcomponents comprising the entirety of a common component. Specifically, the entirety of an automobile driving system as a component is composed of subcomponents such as an engine and a transmission. The entirety of a transmission as a component is also composed of subcomponents such as a gear part, an automatic transmission control apparatus or the like. Thus, a subcomponent may include other subcomponents. Components may also be classified as component groups by dividing components into component groups based on a predetermined criteria, including for example, names or properties of components.

Display section 300 displays a pulldown menu for inputting a utilization method corresponding to a name of a displayed component. When a user clicks the pulldown menu, the pulldown menu displays the list of a plurality of utilization methods (e.g., reuse, co-development, independent design, change and deletion, etc.). A user selects a utilization method from among the plurality of utilization methods to input the selected utilization method to the input accepting section 310. Hereinafter, specific examples of the respective utilization methods will be described.

When receiving an input of a co-development as a utilization method for the component Q, the input accepting section 310 further accepts an input specifying which of a plurality of first development projects is used for the co-development of the component required for the second development project. Based on this input, the input accepting section 310 instructs the display section 300 to display names of a plurality of first development projects corresponding to a menu for which the co-development is selected. Then, the input accepting section 310 allows a user to select, from among the displayed first development projects, a first development project subjected to the co-development with the second development project. In the example of FIG. 5, the project YY and the project ZZ are displayed as candidates for the co-development.

Preferably, the input accepting section 310 may display the plurality of first development projects in the order of the number of components, from the largest number to the smallest number, for which a co-development with the second development project is already planned. For example, when the number of components for the project YY for which a co-development with the second development project is already planned is larger than the number of components for the project ZZ for which a co-development with the second development project is already planned, the input accepting section 310 controls the display so that the project YY is displayed above the project ZZ. This allows a user to easily select components for co-development. More preferably, the input accepting section 310 may display, with regards to the specified component Q and in the component group to which the specified component belongs, a plurality of first development projects in the order of components, from the largest number to the smallest number, for which the co-development with the second development project is already planned. For example, only components illustrated as “P to S” in FIG. 5 are counted in this case and a component A belonging to another component group is not counted. As a result, the number of components subjected to the co-development is evaluated for every subcomponent. Thus, a user easily selects components for the co-development.

When a design change utilization method is selected for the component S, the input accepting section 310 further accepts a ratio of man-hours among the choices of man-hours of the operation processes for the component S as required in the first development project, in order to realize the design change of the component S in the second development project. Based on this input, the input accepting section 310 shortens the operation processes for the component S of the first development project using the selected man-hour ratio, and copies the shortened operation processes, thereby generating an operation process for the component in the second development project. For example, the input accepting section 310 may change the operation processes requiring 10 days in the first development project to an operation processes requiring 5 days, which is 50% of 10 days. The ratio at which the operation processes is shortened also may be predetermined regardless of an input from a user.

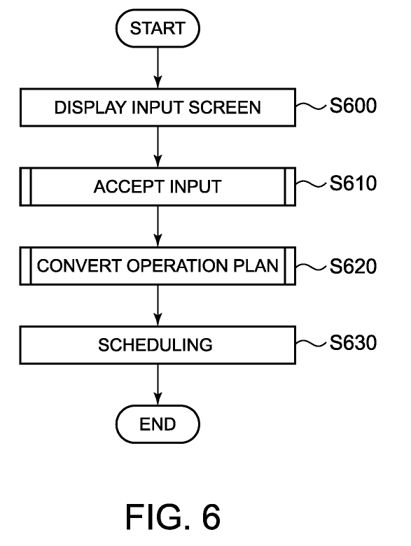

FIG. 6 illustrates the flow of the process in which preparation support system 30 converts the operation processes based on the accepted input. The display section 300 displays an input screen through which a user inputs a utilization method for the first development project having a timetable already prepared and the second development project for which a new timetable is prepared (S600). The input accepting section 310 accepts, for each of components to be developed, a utilization method for using the first development project in the second development project (S610). Then, the plan conversion section 320 converts, for each of components, a plurality of operation processes planned in the first development project based on the selected utilization method; and generates a plurality of operation processes for developing the component in the second development project (S620). Based on the respective operation processes, the schedule section 330 schedules the respective operation processes and generates a timetable for the second development project and stores the timetable in the development project DB apparatus 20 (S630).

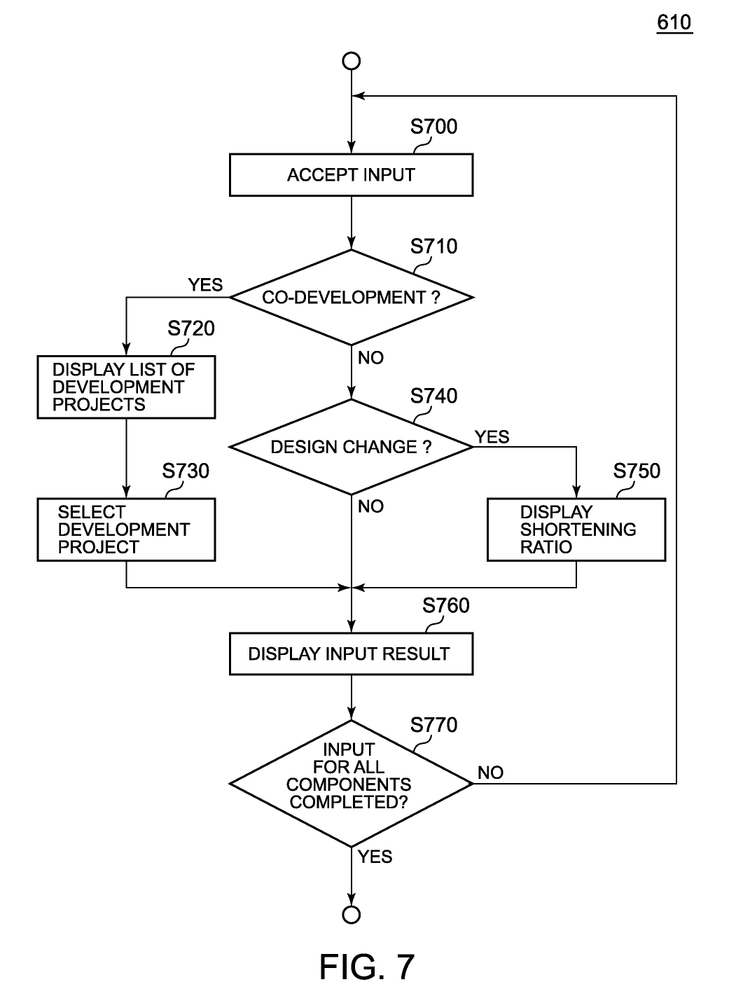

FIG. 7 shows the details of the processing in S610. When accepting an input of a utilization method for a certain component (S700), the input accepting section 310 determines whether the component of the utilization method should be subject to a co-development S710). If the component of the utilization method should be subject to a co-development (S710: YES), then the input accepting section 310 displays the list of a plurality of first development projects. The list displays the first development projects for which the development is not yet completed. When start dates for the respective development projects are specified, the input accepting section 310 compares the respective starting dates with a current date to display only not-yet-started development projects (S720). As described above, the input accepting section 310 may also display the development project in an order of the number of components for which a co-development with the second development project is already planned. Then, the input accepting section 310 allows a user to select, from among the displayed plurality of first development projects, the one to be subjected to a co-development with the second development project (S730).

When a utilization method is not subject to a co-development (S710: NO), the input accepting section 310 determines whether the inputted utilization method is a design change (S740). When the utilization method is a design change (S740: YES), the input accepting section 310 displays a ratio of man-hours of the operation process of the component S. In this example the first development project is shortened (S750). This ratio is displayed as a rated value in the pulldown menu. Thus, a user changes this ratio by operating the menu. The result of the input of the utilization method is displayed on the display section 300 as a selected item from the pulldown menu (S760).

When utilization methods for all components have been selected (S770: YES), the input accepting section 310 completes the process as shown in FIG. 7. When there is a component for which a utilization method is not yet specified, the input accepting section 310 returns to the step S700.

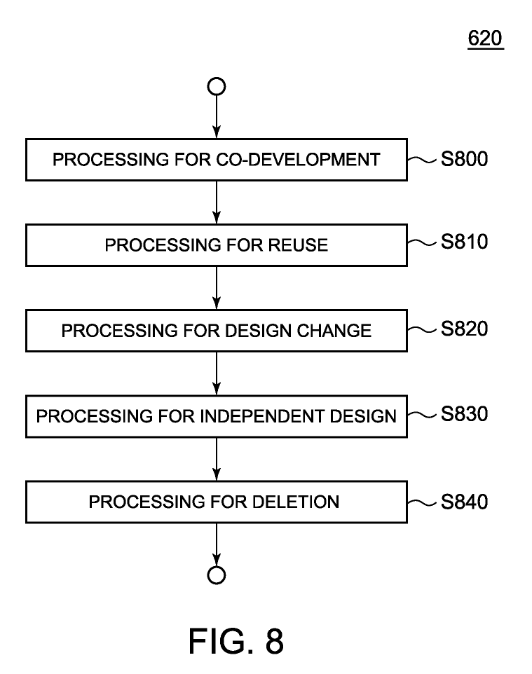

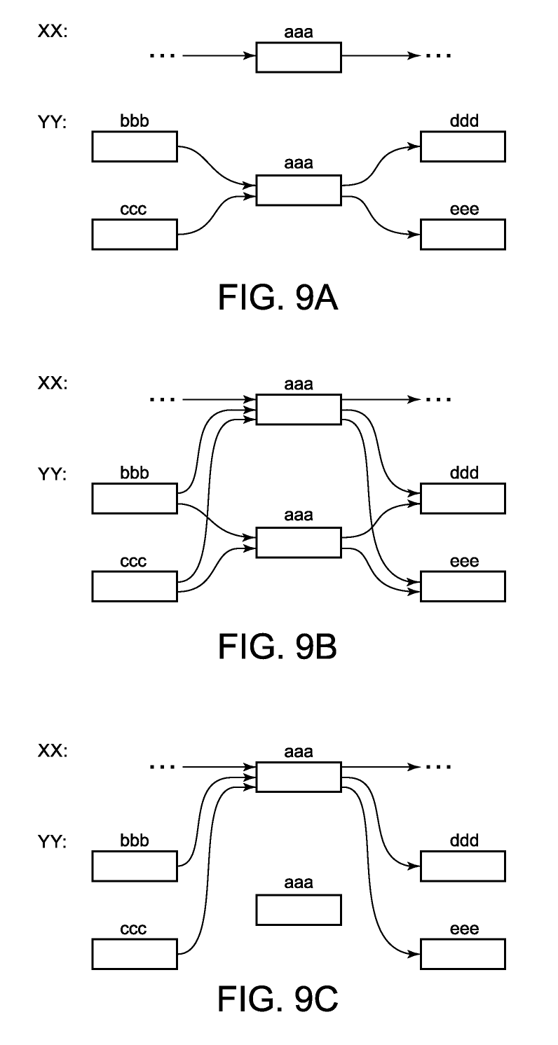

FIG. 8 illustrates the details of the process in S620. When receiving an input specifying that a certain component in the second development project should be subject to a co-development with the first development project, the plan conversion section 320 incorporates an operation time schedule of a plurality of operation processes corresponding to the component in the first development project as an operation time schedule of a plurality of operation processes for developing the component in the second development project (S800). FIGS. 9A, 9B, and 9C show an example thereof.

FIGS. 9A, 9B, and 9C show a process for incorporating an operation process when a component is subject to a co-development utilization method. For example, a component which is subject to a co-development (which will be referred to as component K) is developed by the operation process aaa. As shown in FIG. 9A, the plan conversion section 320 reads a prepared timetable of the first development project from the development project DB apparatus 20 in order to prepare a timetable of the second development project (which will be referred to as project YY). The timetable of the first development project is temporarily handled as a timetable of the second development project. In the second development project, the operation process aaa depends on the operation process bbb and the operation process ccc. The operation process ddd and the operation process eee depend on the operation process aaa.

With regards to the respective components, the input accepting section 310 accepts an input of a utilization method for the first development project (project XX in this case), which will also be used for the project YY. For example, the input accepting section 310 accepts an input of a utilization method specifying that component K is subject to co-development with the project XX. Based on the utilization method, the plan conversion section 320 searches each of the other operation processes having a dependence relationship with the operation process aaa of the project YY in which component K is developed. This search is performed by scanning the dependence relationship table of project YY. In the example of FIG. 9, the operation process bbb, the operation process ccc, the operation process ddd, and the operation process eee are also searched.

As shown in FIG. 9B, the plan conversion section 320 connects the respective searched operation processes to the operation process aaa in the project XX via links. As a result, the operation process in project XX of component K is incorporated into project YY. It is noted that other operation processes (depending on the operation process aaa of project XX) still depend on operation process aaa and are not affected by the co-development. Similarly, other operation processes in project XX on which the operation process aaa depends, remain unchanged. As shown in FIG. 9C, the plan conversion section 320 deletes the link in project YY connected to the operation process aaa.

When co-development is planned, the schedule section 330 schedules an operation process based on a newly-connected link. For example, schedule section 330 scans a table containing all dependence relationships from the upstream side to generate operation time schedules. The time schedules are generated according to the respective operation processes, which can be started at the earliest dates. The earliest dates at which the respective operation processes can be started are determined based on a date at which an upstream operation process of the operation process is completed, or an operation time schedule already planned for an operation process of a component for which co-development is planned. For example, operation starting dates of the operation process ddd and the operation process eee in FIG. 9C are determined based on conditions used for general forward scheduling, and a condition that the operation starting dates must be later than a date at which the operation process aaa in project XX is completed. Thus, operation time schedules for other operation processes that depend on a plurality of operation processes corresponding to a component subject to a co-development or on which a plurality of operation processes corresponding to the component depend, are scheduled so as to satisfy an operation time schedule already prepared in project XX for an operation process corresponding to the component subject to co-development.

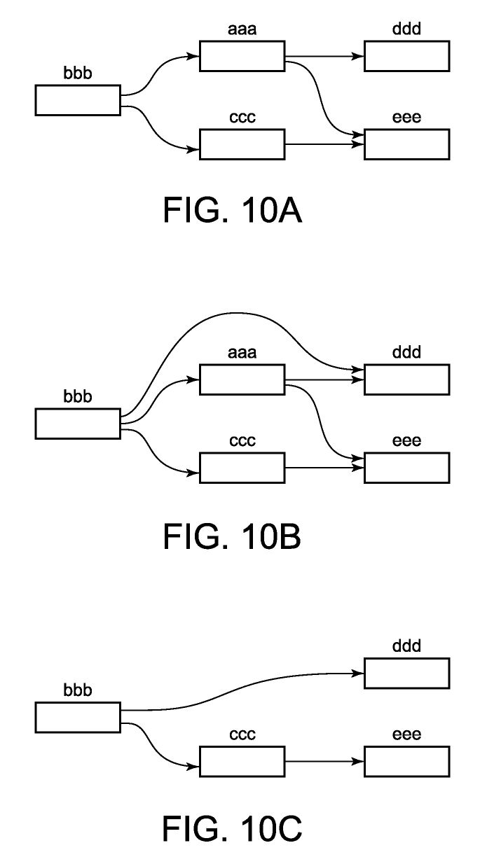

Returning to FIG. 8, plan conversion section 320 accepts an input specifying the development of a component having substantially the same design as that of a component developed in an already-completed first project. Based on this input, plan conversion section 320 excludes an operation process corresponding to the component from the operation plan for the second development project (S810). FIG. 10 shows an example.

FIGS. 10A, 10B, and 10C illustrate a process for converting an operation process when a component is reused or deleted. When a new development project reuses substantially the same design as that of an already-completed development project, then the new development project requires substantially no additional man-hours. The plan conversion section 320 deletes the operation process for developing the component. When a new development project does not use a component developed in an existing development project, the operation process for developing the component is also deleted. In FIGS. 10A, 10B, and 10C, the operation process aaa is deleted.

In order to delete an operation process, the plan conversion section 320 determines whether a dependence relationship between the respective previous processes of the operation process aaa (other operation processes on which the operation process aaa directly depends) and the respective subsequent processes of the operation process aaa (other operation processes that directly depend on the operation process aaa) is still defined when the operation process aaa is excluded. In the example shown in FIG. 10A, plan conversion section 320 determines whether a dependence relationship is defined between the operation process bbb and the operation process ddd. The plan conversion section 320 also determines whether a dependence relationship is defined between the operation process bbb and the operation process eee. When no dependence relationship is defined with regards to a certain combination of operation processes, the plan conversion section 320 newly prepares a dependence relationship for the combination. In the example of FIG. 10B, a dependence relationship through which the operation process bbb directly depends on the operation process ddd is prepared. Then, the plan conversion section 320 excludes the operation process aaa from the development project as shown in FIG. 10C to delete all dependence relationships between the operation process aaa and all other operation processes.

Returning to FIG. 8, plan conversion section 320 accepts an input specifying that the component in an existing development project has changed in order to prepare the component for a new development project. Based on this input, plan conversion section 320 shortens the man-hours required for an operation process corresponding to the component in the existing development project based on a predetermined ratio, thus using the man-hour requirements for an operation process corresponding to the component in the new development project (S820). As already described, the ratio by which a man-hour requirement is shortened may also be specified by a user. Thus, the number of man-hours required for the change of a component can be determined in accordance with the period required for when the component is first developed.

Next, the plan conversion section 320 receives an input specifying that the component in a new development project is independently designed from the component in an existing development project. Based on this input, the plan conversion section 320 copies the operation process of the component in the existing development project and uses this operation process for the component in the new development project (S830). By doing this, the man-hours required for the development of a component having a new design can be estimated using the man-hour requirement for development of the same type of the component. The plan conversion section 320 also receives an input specifying that the component is deleted. Based on this input, the plan conversion section 320 deletes the operation process for developing the component (S840). The details of the deletion processing are the same as those described with reference to FIG. 10 and thus will not be described further.

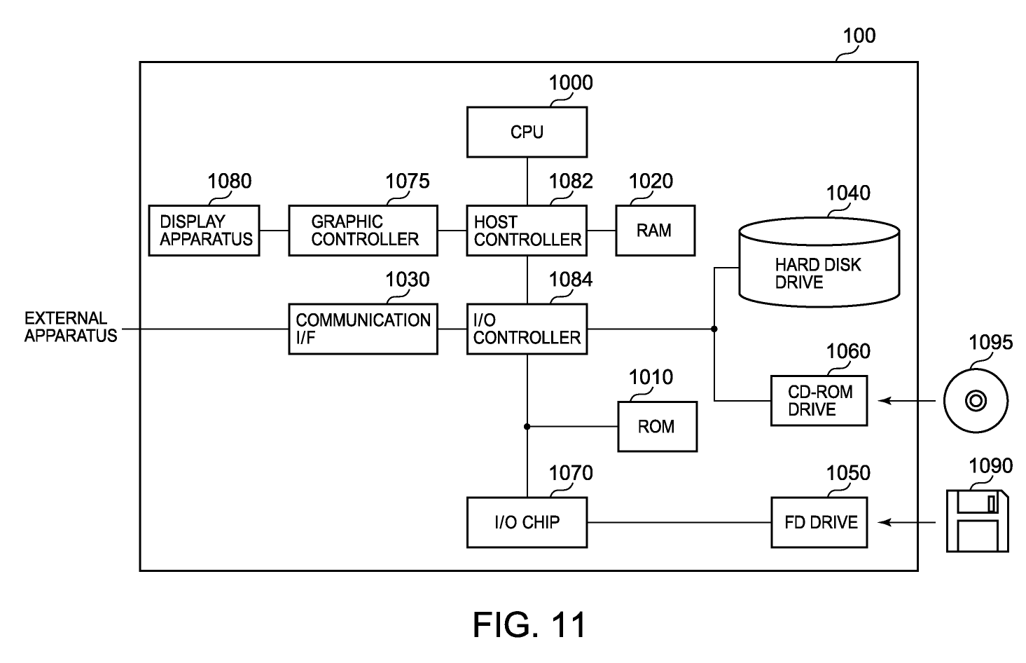

FIG. 11 shows an example of a hardware configuration of an information processing apparatus 100 functioning as the preparation support system 30. The information processing apparatus 100 has a CPU periphery section having a CPU 1000, a RAM 1020, and a graphic controller 1075 mutually connected to one another via a host controller 1082; an input/output section having a communication interface 1030, a hard disk drive 1040, and a CD-ROM drive 1060 connected by an input/output controller 1084 to the host controller 1082; and a legacy input/output section having a flexible disk drive 1050 and an input/output chip 1070 connected to the input/output controller 1084.

The host controller 1082 connects the RAM 1020 with the CPU 1000 and the graphic controller 1075 accessing the RAM 1020 with a high transfer rate. The CPU 1000 operates based on program products stored in the ROM 1010 and the RAM 1020 to control the respective parts. The graphic controller 1075 acquires image data generated on a frame buffer provided in the RAM 1020 by the CPU 1000 or the like to cause the image data on the display apparatus 1080. Alternatively, the graphic controller 1075 also may include a frame buffer for storing image data generated by the CPU 1000 or the like.

The input/output controller 1084 connects the host controller 1082 to the communication interface 1030, the hard disk drive 1040, and the CD-ROM drive 1060 as a relatively high speed input/output apparatus. The communication interface 1030 has communication with external apparatuses via network. The hard disk drive 1040 stores therein a program product and data used by the information processing apparatus 100. The CD-ROM drive 1060 reads the program product or data from the CD-ROM 1095 to provide the program product or data to the RAM 1020 or the hard disk drive 1040.

The input/output controller 1084 is connected with the ROM 1010 and a relatively low speed input/output apparatus such as the flexible disk drive 1050 and the input/output chip 1070. The ROM 1010 stores a boot program product executed by the CPU 1000 when the information processing apparatus 100 is activated and a program product depending on the hardware of the information processing apparatus 100 for example. The flexible drive 1050 reads the program product or data from the flexible drive 1090 to provide the program product or data to the RAM 1020 or the hard disk drive 1040 via the input/output chip 1070. The input/output chip 1070 connects various input/output apparatuses via the flexible drive 1090, a parallel port, a serial port, a keyboard port, or a mouse port for example.

The program product provided to the information processing apparatus 100 is provided by a user while being stored in a recording medium such as the flexible disk 1090, the CD-ROM 1095, or an IC card. The program product is read out from the recording medium via the input/output chip 1070 and/or the input/output controller 1084 and is installed in and executed by the information processing apparatus 100. An operation that is prompted by a program product to cause the information processing apparatus 100 or the like to execute the operation is the same as that in the preparation support system 30 described with reference to FIG. 1 to FIG. 10 and thus will not be described further.

The program product as described above also may be stored in an external storage medium. A storage medium includes, in addition to the flexible drive 1090 and the CD-ROM 1095, an optical recording medium (e.g., DVD, PD), a magneto optical recording medium (e.g., MD), and a semiconductor memory (e.g., tape medium, IC card) for example. Alternatively, a storage apparatus such as a hard disk or a RAM provided in a server system connected to an exclusive communication network or the Internet also may be used as a recording medium and may be used to provide the program product to the information processing apparatus 100 via the network.

As described above, according to the preparation support system 30 according to this embodiment, a utilization method of a project for which a timetable is already prepared can be inputted for every component to be developed, thus eliminating the need for a detailed analysis of an existing operation plan table, for example, to quickly and efficiently estimate a work period required for the project. Furthermore, the utilization method is not limited to the use of an operation schedule and may be the co-development of a project with another project that executes in parallel with the project. Thus, preparation of a plan can be supported in accordance with the real-time condition of automotive industry, for example.

As described above, the present invention has been described by way of embodiments. However, the technical scope of the present invention is not limited to the range described in the above embodiments. Modification or change to the above embodiments is possible as is clear for those skilled in the art. For example, the display section 300 also may display, the progress of a development project. Specifically, the input accepting section 310 accepts inputs from responsible persons of operation processes with regards to man-hours required in order to calculate the total number of the man-hours. The input accepting section 310 also deducts the calculated total man-hours from the total man-hours planned in the development project to further calculate the man-hours required in the future. Display section 300 then displays the calculated man-hours to a manager, for example. Man-hours may also be separately calculated to provide a man-hour number which excludes operation man-hours for co-development and a separate number of man-hours which include operation man-hours for co-development. These man-hours values may be separately displayed. Such an embodiment including modification or improvement may also be included in the technical scope of the present invention, as can be seen from the description and the claims.

What is claimed is:

1. A system for supporting preparation of an timetable for a development project, comprising:
an input accepting section for accepting, for each of a plurality of components to be developed, a utilization method by which a first development project having a first timetable is used to generate a second timetable for a second development project;
a plan conversion section for converting, for each of the plurality of components, a first plurality of operation processes of the first development project into a second plurality of operation processes for developing the plurality of components in the second development project; and
a schedule section for scheduling the second plurality of operation processes to generate the second timetable for the second development project.

2. The system according to claim 1, wherein
the first development project proceeds in parallel with the second development project;
the utilization method specifying that a first component in the second development project is subject to co-development with the first development project;
the plan conversion section incorporates the first plurality of operation processes corresponding to the first component in the first development project with the second plurality of operation processes for co-developing the first component in the second development project; and
the schedule section creates a second timetable having the second plurality of operation processes that depend on the first plurality of operation processes corresponding to the first component or on which the second plurality of operation processes depend, so as to satisfy the first timetable of the first development project for the first component.

3. The system according to claim 2, wherein
the first plurality of operation processes are represented as a first set of data having a structure in which the first plurality of operation processes are linked according to a first plurality of dependence relationships; and
wherein the plan conversion section links the second plurality of operation processes to the first plurality of operation processes corresponding to a second plurality of dependence relationships, which correspond to the development of the first component in the second development project.

4. The system according to claim 2, wherein
the input accepting section displays a plurality of development projects for which co-development with the second development project is planned; and a user selects from among the displayed plurality of development projects, a third development project being subject to co-development with the second development project.

5. The system according to claim 4, wherein
the second plurality of components to be developed by the second development project are classified into a plurality of component groups; and
the input accepting section displays a specified one of the second plurality of components in one of the pluralities of component groups of one of the pluralities of development projects for which co-development with the second development project is planned, such that a user selects one of the plurality of development projects subject to co-development with the second development project.

6. The system according to claim 1, wherein
the utilization method is an exclusion method and the plan conversion section excludes one of the first plurality of operation processes corresponding to the first component from the second development project if the first component is substantially the same design as that of a second component of the first development project, the first development project having been completed.

7. The system according to claim 1, wherein
the plan conversion section shortens a man-hour value of one of the first plurality of operation processes corresponding to the first component in the first development project using a predetermined ratio; and further uses the shortened man-hour value to generate the plurality of second operation processes for the first component in the second development project.

8. The system according to claim 1, wherein
the plan conversion section copies the first plurality of operation processes for the first component in the first development project, and generates a second plurality of operation processes for a second component in the second development project;
wherein the second component in the second development project is independently designed from the first component in the first development project.

9. A method of supporting preparation of a timetable of a development project, comprising the steps of:
accepting, for each of a plurality of components to be developed, a first utilization method for the first development project having a first timetable which is then used in the second development project to generate a second timetable;
converting, for each of the plurality of components, a plurality of first operation processes planned in the first development project based on the first utilization method in order to generate a second plurality of operation processes for developing the plurality of components in the second development project; and
generating the second timetable for the second development project based on the second plurality of operation processes.

10. A program product for causing an information processing apparatus to function as a system for supporting preparation of a timetable for a development project comprising:
an input accepting section for accepting, for each of a plurality of components to be developed, a first utilization method by which a first development project having a first timetable is used for a second development project to create a second timetable;
a plan conversion section for converting, for each of the plurality of components, a first plurality of operation processes planned in the first development project based on the first utilization method for each of the plurality of components, to generate a second plurality of operation processes for developing the plurality of components in the second development project; and
a schedule section for scheduling the second development project based on the second plurality of operation processes, wherein the scheduled second plurality of operation processes is stored in the second timetable.
